(19) United States
(12) Patent Application Publication
(10) Pub. No.: US 2010/0307538 A1
(43) Pub. Date: Dec. 9, 2010

(54) MILK COLLECTION DEVICE, AND MILKING DEVICE AND METHOD THEREWITH

(75) Inventor: Gerrit Vernon Jessup NEWTON, DELFT (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: LELY PATENT N.V., MAASSLUIS (NL)

(21) Appl. No.: 12/858,452

(22) Filed: Aug. 18, 2010

Related U.S. Application Data
(63) Continuation of application No. PCT/NL2009/000024, filed on Feb. 4, 2009.

(30) Foreign Application Priority Data
Feb. 18, 2008 (NL) 1035034

(51) Int. Cl. B08B 9/00

(52) U.S. Cl. 134/22.1; 134/166 R

(57) ABSTRACT

A system and method for a milk collection device comprising a milk collection container having a rinsing liquid supply line, at least one milk supply, a vacuum discharge tube and a liquid discharge on the bottom side of the container, wherein the rinsing liquid supply is provided atop the milk collection container and separated from the vacuum discharge tube, and is arranged to guide the rinsing liquid substantially along a wall of the milk collection container and to wash around the vacuum discharge tube with rinsing liquid on at least two sides. Consequently, rinsing liquid is supported by vacuum, while still being able to rinse substantially the entire wall surface of the milk collection container. The invention also provides a milking device and a working method with the milk collection device.

### CROSS REFERENCE TO RELATED APPLICATIONS

This application is a continuation of PCT application serial number PCT/NL2009/000024, filed on Feb. 4, 2009, and claims priority from Netherlands application number 1035034, the contents of which are hereby incorporated by reference in their entirety.

### BACKGROUND OF THE INVENTION

1. Field of the Invention

The invention relates to a milk collection device comprising a milk collection container having a rinsing liquid supply line, at least one milk supply, a vacuum discharge tube and a liquid discharge on the bottom side of the container, wherein the rinsing liquid supply is provided atop the milk collection container and separated from the vacuum discharge tube, and is arranged to guide the rinsing liquid substantially along a wall of the milk collection container.

2. Description of the Related Art

Milk collection devices are on the market, such as for example by the company Lely Industries N.V. in a milking device with the name Astronaut A3. This milking device comprises, in addition to teat cups, means to apply these and a vacuum system, a milk collection container. The latter is sometimes referred to as milk jar and should not be confused with the milk tank, which is meant for final storage. The milk collection container of the known milk collection device has a vacuum discharge tube placed centrally atop of it, a rinsing liquid supply on one side and, on the opposite side, four milk tube connections stemming from the four teat cups.

A disadvantage of the known milk collection device is that a part of the milk collection container cannot be cleaned properly upon rinsing of the milk collection container, which may have detrimental consequences for the milk quality.

### BRIEF SUMMARY OF THE INVENTION

The present invention addresses these problems by providing a milk collection device wherein the milk collection container is rinsed more completely and effectively and, thus, to ensure an improved milk quality. The invention achieves this object by providing comprising a milk collection container having a rinsing liquid supply, at least one milk supply, a vacuum discharge tube and a liquid discharge, wherein the rinsing liquid supply is arranged as a concentric conduit and comprises at least two rinsing liquid supply openings that are disposed atop the milk collection container and separated from the vacuum discharge tube, and are arranged to guide the rinsing liquid substantially along an inner wall of the milk collection container, and wherein the rinsing liquid supply is arranged to wash around the vacuum discharge tube with rinsing liquid on at least two sides of the vacuum discharge tube. It appears that a larger part of the milk collection container can be rinsed in this manner.

The fact is that in practice it has appeared that in the known milk collection device a kind of ‘shadow’ occurs behind the vacuum discharge tube, which cannot be reached by rinsing liquid, because the rinsing liquid is obstructed by the vacuum discharge tube, or even extracted by it. Consequently, the ‘shadow area’ will not be cleaned by the rinsing liquid, so that milk residues can deposit there, which is bound to lead to detrimental effects. By providing rinsing liquid according to the invention from a plurality of directions that are sufficiently different, there will only remain a shadow (‘core shadow’ or umbra) where the partial shadows or penumbrae from the different directions overlap one another. This core shadow is smaller than each of the partial shadows, so that the quality of cleaning and, hence, the milk quality is improved. Here, providing from an opening of a conduit should be interpreted as providing from one direction, in particular the average direction.

If the two directions enclose a right angle, the core shadow is already very small. Advantageously, the two directions substantially enclose a straight angle, i.e. at least 160° and, more advantageously, 180°. As a result of this, the core shadow is reduced to almost nil.

It should be noted here that a milk jar is known from GB2049624, hereby incorporated by reference, that a vacuum can be discharged, or rinsing liquid supplied through one and the same conduit. In this case, a non-return valve ensures that the vacuum passage is largely closed off upon supplying rinsing liquid and that there remains only a small passage, along a dispersion plate, so that the liquid can flow along the wall of the milk jar. However, this device is unfit for simultaneous discharge of vacuum and supply of rinsing liquid. This is advantageous, however, because in this manner the vacuum discharge tube can support the rinsing liquid flow, thus for example increasing the cleaning power. Moreover, in principle, an additional pump for the rinsing liquid need not be provided, because the vacuum system that is available as it is can also be used for the supply of rinsing liquid, so that a simpler layout of the total system is possible. Contrary to this known device, the device according to the present invention is actually suitable for simultaneous discharge of vacuum and supply of rinsing liquid.

In one embodiment according to the present invention the device is arranged to provide rinsing liquid from two directions in that they comprise two rinsing liquid lines that flow out into the milk collection container. In a further embodiment, the device comprises at least three rinsing liquid supply openings around the vacuum discharge tube, in particular spread regularly around the vacuum discharge tube. Because of this, not only can every remainder of the core shadow be removed, but in addition a larger portion of the milk collection container can be rinsed from a plurality of directions, which further improves the cleaning result. More than two directions, with a corresponding number of openings, are possible as well.

In a further embodiment, the rinsing liquid supply is provided as a concentric conduit around the vacuum discharge tube. In particular, the rinsing liquid supply is provided as a concentric chink around the vacuum discharge tube. This provides not only the advantage that the vacuum discharge tube is washed around from all directions, thus eliminating the occurrence of a shadow, but at the same time it provides the advantage that the number of rinsing liquid supply openings needed to that effect is restricted as much as possible, i.e. basically to one, although the chink in itself may be split up in a plurality of partial chinks. Strictly speaking, in this embodiment, the rinsing liquid does not necessarily have to be washed to the vacuum discharge tube. If there is a certain distance between the supply and discharge, for example because of a level wall segment, then that may still be useful. However, if there is only the thickness of a conduit wall between the supply chink and the vacuum discharge tube, then it is recommendable to supply rinsing liquid only away from the vacuum discharge tube.

In particular embodiments, the rinsing liquid supply connects to the milk collection container with a curvature, wherein the curvature shows an at least constant, and preferably steadily increasing curvature radius in the direction of the rinsing liquid supply to the milk collection container. Such an embodiment ensures that the rinsing liquid flow is guided effectively along the wall of the milk collection container and that it washes the latter out. To achieve this, a ‘trumpet-shaped’ design of the connection between the supply and the milk collection container may be envisaged. As an alternative, the rinsing liquid supply may also be differently arranged to guide the liquid along the wall, for example by means of a dispersion plate. Advantageously, the dispersion plate is fastened to the vacuum discharge tube, or the vacuum discharge tube has an outflow outlet that is either widened or bent outwards, in the fashion of a dispersion plate. All of these examples support the adhesion of the rinsing liquid to the wall of the milk collection container.

In a further embodiment, the rinsing liquid supply is arranged to provide the rinsing liquid in the milk collection container with a speed component that is perpendicular to an axial direction of the vacuum discharge tube, at the point where it connects to the milk collection container. With such an embodiment, the rinsing liquid is provided, as it were, in a ‘whirling’ or ‘rotating’ manner, which ensures at the same time that the liquid is properly guided along the wall of the milk collection container. In addition, the rinsing liquid will be guided entirely or substantially along the wall of the rinsing liquid supply. In particular in the case of the concentric conduit or chink around the vacuum discharge tube, this will increase the efficiency of the rinsing liquid supply.

According to another aspect of the present invention, a milking device comprising a milk collection device further comprises a box having a framework, on which is disposed a movable robot arm which is arranged to apply teat cups, which teat cups are connected to the milk collection container by of one or more milk tubes. Such a milking device is pre-eminently suitable for automatic milking, for which device it is advantageous that the cleaning of the milk collection container can take place in an effective and reliable manner.

In relation to such automatic milking devices, which are also briefly named ‘milking robots’, embodiments are conceivable wherein a cow can access and leave the box through doors or gates that are disposed on the long side of the box. With such devices, two doors are disposed on one side. These can be positioned on the left-hand or right-hand side. Accordingly, the robot arm and further means such as the milk collection container will be disposed on the respective opposite side. Due to such a mirror-wise configuration there is a possibility that the milk collection container should be disposed in two different orientations with the different embodiments. Therefore, the one or more milk tubes are connected to the milk collection container symmetrically to a plane A, wherein plane A is a plane perpendicular to the longitudinal direction of the box through the centre of the milk collection container. In particular, the milk tubes are connected to a side of the milk collection container that is averted from the box. With this embodiment, at least the milk tubes and the connection to the vacuum discharge tube and essentially the rinsing liquid supply as well may be provided symmetrically to plane A. This requires only one design of the milk collection container for both mirrored versions of the milking robot. This makes production and assembly of the device simpler and less error-prone. In itself, it is possible, also with a non-concentric configuration of the vacuum discharge tube and the rinsing liquid supply, to provide the aforementioned conduits and connections of the milk tubes onto the milk collection container symmetrically to plane A, but in that case many, at least more connections onto the milk collection container in plane A are provided, which increases the chance of obstruction due to the various tubes. With the embodiment according to the invention, this is the case to a lesser degree.

The invention also provides a method of cleaning a milk collection container in a milking device, which container comprises a rinsing liquid supply line, at least one milk supply, a vacuum discharge tube and a liquid discharge on the bottom side, wherein the rinsing liquid supply is provided atop the milk collection container and separated from the vacuum discharge tube, and is arranged to guide the rinsing liquid substantially along a wall of the milk collection container, in particular according to the invention, wherein the method comprises the steps of applying a vacuum by discharging air through the vacuum discharge tube and supplying rinsing liquid through the rinsing liquid supply, wherein, during the discharge of air, the rinsing liquid is supplied in the milk collection container by means of the rinsing liquid supply in such a manner that substantially the entire wall of the milk collection container is cleaned, in particular the wall portion of the milk collection container around the vacuum discharge tube. With this working method, the advantages of reducing the ‘shadow’ may be provided, while at the same time use can be made of the advantage of applying vacuum to the milk collection container during rinsing. It is noted one more time that the aforementioned GB document GB2049624 does not allow simultaneous application of vacuum and a rinsing liquid flow, at least not by means of the connections rendered.

### BRIEF DESCRIPTION OF THE DRAWINGS

The features and advantages of the invention will be appreciated upon reference to the following drawings, in which:

FIG. 1 is a schematic cross-section of a milk collection container of a milk collection device according to the invention;

FIG. 2 is a schematic top view of an embodiment of the milk collection container according to the invention;

FIG. 3 is a schematic top view of another embodiment of the milk collection container according to the invention;

FIG. 4 is a schematic perspective view of an embodiment of the milk collection device according to the invention, and

FIG. 5 is a schematic cross-sectional view of a milk collection container according to the invention.

### DESCRIPTION OF ILLUSTRATIVE EMBODIMENTS

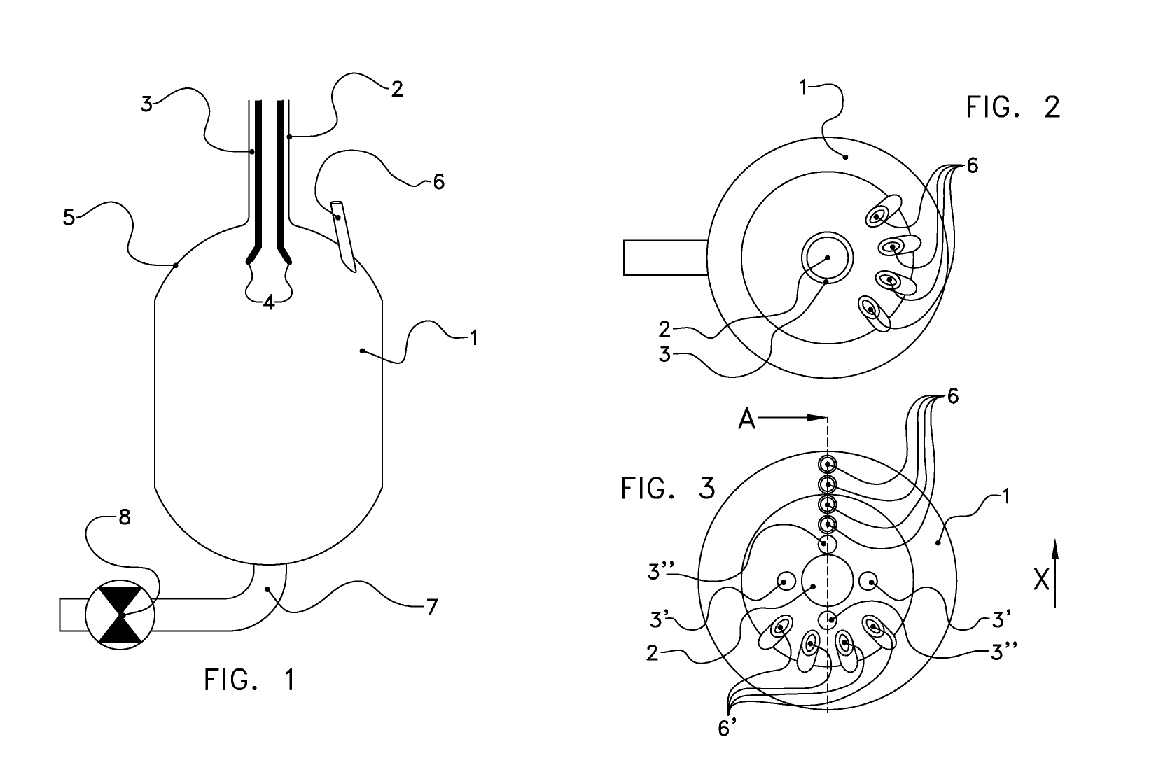

The following is a description of certain embodiments of the invention, given by way of example only and with reference to the drawings. FIG. 1 shows a schematic cross-section of an embodiment of the milk collection device according to the invention. In this figure, 1 is a milk collection container, having a vacuum discharge 2 and a rinsing supply 3 which is provided with a dispersion element 4 at its extremity. Numeral 5 denotes a neck, 6 a milk supply, 7 a milk discharge while numeral 8 denotes a valve.

The milk collection container 1 is notably the kind of milk jar that is used for milking devices. It is notably not a milk tank for bulk storage of milk. Into the milk collection container 1 a vacuum discharge 2 flows out, through which air can be discharged and hence, as it were, vacuum can be supplied. In this case, the vacuum discharge comprises a pipe or tube 2, which ends in a widening dispersion element 4. Although this dispersion element 4 is not necessary, it may be useful in facilitating the discharge of air from the milk collection container 1.

Concentrically around the vacuum discharge 2, a rinsing liquid supply 3 is provided for the supply of rinsing liquid to the inner wall of the milk collection container 1. To ensure effective spreading of the rinsing liquid across the inner wall, a neck 5 is provided between the rinsing liquid supply 3 and the milk collection container 1. The neck 5, starting from the rinsing liquid supply 3, shows a curvature radius that, preferably, increases, i.e. ends in a ‘trumpet-shape’. Consequently, a gradual transition is provided so that there will be proper adhesion of rinsing liquid to the inner wall. It should be noted that in that case the rinsing liquid supply 3 ends in a chink between the dispersion element 4 and the neck 5.

At the bottom of the milk collection container 1, a milk discharge 7 is provided, which can be closed by means of a controllable valve 8. This milk discharge 7 may be connected with, for example, a bulk tank (not shown). Milk can be pumped from the milk collection container 1 by means of a pump that is suitable for liquids. It should be noted that such pumps are seldom suitable for building up vacuum as well. Consequently, the valve 8 will be closed most of the time when rinsing liquid is supplied through the rinsing liquid supply 3. In such a case, vacuum will be provided solely through the vacuum discharge 2. The purpose of this vacuum is to support the supply of rinsing liquid and to enhance its rinsing properties. Usually, there is no (excess) pressure at the rinsing liquid supply, or only a minor pressure, for example 0.5 bar. However, if a vacuum is applied of for example 0.5, or nearly 1 bar, then the total pressure difference is far greater and, hence, the rinsing liquid supply considerably stronger. For this, use is made only of those (vacuum) elements of the milking device that are present anyway.

FIG. 2 shows a schematic top view of a milk collection device according to the invention. Herein, just like in all other figures of the drawing, corresponding components are indicated by the same reference numerals. It can be clearly seen that the rinsing liquid supply 3 constitutes a concentric conduit around the vacuum discharge 2. Furthermore, four milk supply lines 6 are rendered here, for example for a milking device for milking a cow, including four teat cups. A joint milk supply 6 may also be provided.

FIG. 3 shows a schematic top view of another embodiment of the milk collection device according to the invention. Hereby, the four milk supply lines 6 are provided in a plane A, in respect of which the vacuum discharge 2 and two rinsing liquid supply lines 3′ are provided as well. As an option or addition, two rinsing liquid supply lines 3″ may be provided. An advantage of such a milk collection device can be explained as follows. A milk collection device is usually disposed on one side of a box of an automatic milking device. Usually, this is the left-hand or right-hand side of such a box. The assumption is that in the embodiment shown in FIG. 3, the milking box is positioned in the direction marked by the arrow X. The connections for the milk supply lines 6, the vacuum discharge 2 and the rinsing liquid supply 3′ are then provided symmetrically, as a result of which the connections for a mirror-symmetrical embodiment—with the milking box being positioned in the opposite direction—do not have to be re-routed. A comparison can, for example, be made with the embodiment in FIG. 2, wherein this configuration might give rise to problems in relation to the milk supply lines 6. In respect of the embodiment shown in FIG. 3 it may be noted that the alternative rinsing liquid supply lines 3″ are also provided in plane A, as a result of which an entirely symmetrical configuration is provided. The four milk supply lines 6 might also be provided radially, i.e. on the arc of a circle around the centre of the vacuum discharge 2, as shown in FIG. 2, but then in a mirror-symmetrical configuration in respect of plane A. Especially if provided at a large distance from the centre, the milk supply by the milk supply lines 6 takes place substantially along the wall and, hence, with less formation of foam. One of these possible, alternative configurations is rendered by means of striped lines, by reference numeral 6′.

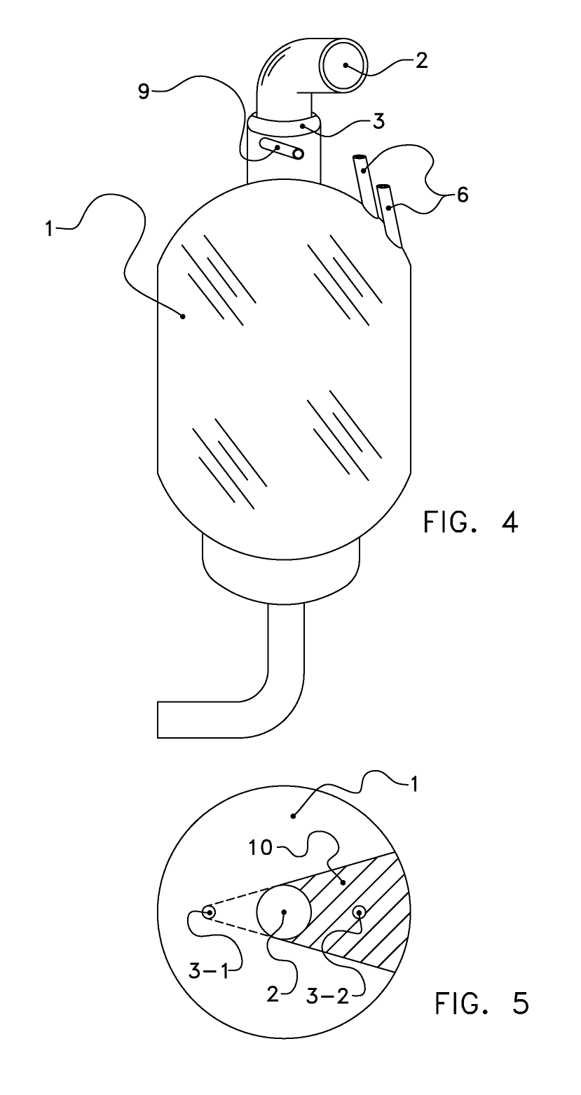

FIG. 4 shows a schematic perspective view of the top side of a milk collection device according to the invention. Herein, 2 again denotes a vacuum discharge, which is surrounded by a rinsing liquid supply 3, onto which a rinsing liquid line 9 is connected eccentrically. It can be clearly seen that the supply of rinsing liquid takes place eccentrically in respect of the concentric vacuum discharge 2. This makes it simple to add a speed component to the rinsing liquid, which ensures that the rinsing liquid supply 3 provides the liquid in the milk collection container 1 in a somewhat whirling or rotating manner. This increases the ‘adhesion’ of the rinsing liquid to the wall of the container 1; at any rate it supports its movement along the wall of the container.

FIG. 5 shows a schematic view of an embodiment of the milk collection device according to the invention. In this FIG. 5, the functioning of the invention is explained schematically. Again, 2 denotes a vacuum discharge. Rinsing liquid is supplied through the rinsing liquid supply 3-1. This figure is based upon the assumption that the rinsing liquid's movement does not involve a component for rotation or whirling. In principle, it will be possible for the rinsing liquid to reach the entire wall of the milk collection container 1, with the exception of the shaded area 10, also referred to as ‘shadow’. It can be clearly seen that the rinsing liquid supply 3-2 can furnish (well-nigh) the full shadow area 10 with rinsing liquid. Moreover, rinsing liquid will be applied from at least two directions to a major portion of the wall of the milk collection container 1, which may enhance the cleaning effect. It should be noted that in case of supply of a rinsing liquid of which the movement includes a rotation component, the shadow may have a different shape, but that its total elimination is not possible.

Thus, the invention has been described by reference to certain embodiments discussed above. It will be recognized that these embodiments are susceptible to various modifications and alternative forms well known to those of skill in the art. Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A milk collection device comprising a milk collection container having a rinsing liquid supply, at least one milk supply, a vacuum discharge tube and a liquid discharge, wherein the rinsing liquid supply is arranged as a concentric conduit and comprises at least two rinsing liquid supply openings that are disposed atop the milk collection container and separated from the vacuum discharge tube, the rinsing liquid supply openings arranged to guide the rinsing liquid substantially along an inner wall of the milk collection container, and wherein the rinsing liquid supply is arranged to wash around the vacuum discharge tube with rinsing liquid on at least two sides of the vacuum discharge tube.

2. The milk collection device according to claim 1, wherein the rinsing liquid supply is arranged to provide, from at least two directions, rinsing liquid to the vacuum discharge tube, wherein the two directions enclose at least a right angle.

3. The milk collection device according to claim 2, wherein the two directions substantially enclose a straight angle.

4. The milk collection device claim 1, comprising at least three rinsing liquid supply openings around the vacuum discharge tube.

5. The milk collection device according to claim 1, wherein the rinsing liquid supply is provided as a concentric chink around the vacuum discharge tube.

6. The milk collection device according to claim 1, wherein the rinsing liquid supply connects to the milk collection container with a curvature, wherein the curvature shows an at least constant curvature radius in the direction of the rinsing liquid supply to the milk collection container.

7. The milk collection device according to claim 6, wherein the curvature is a steadily increasing curvature radius in the direction of the rinsing liquid supply to the milk collection container.

8. The milk collection device according to claim 1, wherein the rinsing liquid supply is arranged to provide the rinsing liquid in the milk collection container with a speed component that is perpendicular to an axial direction of the vacuum discharge tube, at a point where it connects to the milk collection container.

9. A milking device comprising a milk collection container having a rinsing liquid supply, at least one milk supply, a vacuum discharge tube and a liquid discharge, wherein:
the rinsing liquid supply is arranged as a concentric conduit and comprises at least two rinsing liquid supply openings that are disposed atop the milk collection container and separated from the vacuum discharge tube, and wherein the rinsing liquid supply openings are arranged to guide the rinsing liquid substantially along an inner wall of the milk collection container, and
the rinsing liquid supply is arranged to wash around the vacuum discharge tube with rinsing liquid on at least two sides of the vacuum discharge tube, and
wherein the milking device further comprises a box having a framework on which is disposed a movable robot arm arranged to apply teat cups that are connected to the milk collection container via one or more milk tubes.

10. The milking device according to claim 9, wherein the one or more milk tubes are connected to the milk collection container symmetrically to a plane A, wherein plane A is a plane perpendicular to the longitudinal direction of the box through the centre of the milk collection container.

11. A method of cleaning a milk collection container in a milking device, the milk collection container comprising a rinsing liquid supply, at least one milk supply, a vacuum discharge tube and a liquid discharge, wherein:
the rinsing liquid supply is arranged as a concentric conduit and comprises at least two rinsing liquid supply openings that are disposed atop the milk collection container and separated from the vacuum discharge tube, and wherein the rinsing liquid supply openings are arranged to guide the rinsing liquid substantially along an inner wall of the milk collection container, and
the rinsing liquid supply is arranged to wash around the vacuum discharge tube with rinsing liquid on at least two sides of the vacuum discharge tube,
wherein a vacuum is applied to the container by discharging air through the vacuum discharge tube and supplying rinsing liquid through the rinsing liquid supply, and
wherein during the discharge of air, the rinsing liquid is supplied in the milk collection container through the rinsing liquid supply such that substantially the entire wall of the milk collection container is cleaned.

12. The method according to claim 11, wherein the wall portion of the milk collection container around the vacuum discharge tube is cleaned.

13. The method of according to claim 11, wherein rinsing liquid is supplied in the direction of the vacuum discharge tube from at least two directions, wherein the two directions enclose at least a right angle.

14. The method according to claim 13, wherein the two directions substantially enclose a straight angle.

15. The method according to claim 11, comprising at least three rinsing liquid supply openings around the vacuum discharge tube.

16. The method according to claim 11, wherein the rinsing liquid supply is provided as a concentric chink around the vacuum discharge tube.
